(19) United States
(12) Patent Application Publication
(10) Pub. No.: US 2022/0044333 A1
(43) Pub. Date: Feb. 10, 2022

(54) Tax Profile Authorizations

(71) Applicant: ADP, LLC, Roseland, NJ (US)

(72) Inventor: Roel Punzalan, Pasadena, CA (US)

(21) Appl. No.: 16/985,843

(22) Filed: Aug. 5, 2020

(51) Int. Cl. G06Q 40/00; G06F 21/32

(52) U.S. Cl. CPC G06Q 40/123; G06F 21/32

(57) ABSTRACT

Electronic submission of tax profile authorizations via a network is provided. A tax profile authorization form corresponding to a tax agency is populated using stored information in a set of tax profile jurisdiction databases created by a client. An electronic signature of an authorized signer of the client is applied to the tax profile authorization form. The signed tax profile authorization form is submitted to the tax agency via the network enabling a third-party entity to respond to employment tax matters on behalf of the client before the tax agency. An indication is displayed on a tax profile authorization dashboard that the signed tax profile authorization form has been submitted to the tax agency. Third-party administrator authorization with client information and tax jurisdiction is displayed on the tax profile authorization dashboard, along with timestamp of the electronic signature of the authorized signer for verification and fraud prevention.

### BACKGROUND

### 1. Field

The disclosure relates generally to third-party authorizations and more specifically to automatically completing, validating, and submitting tax profile authorizations that give a third-party entity providing an employment tax service permission to act in a client's behalf before a tax agency regarding employment tax matters.

### 2. Description of the Related Art

Two major reasons exist for granting third-party authorization to resolve tax-related matters. The first reason for granting the authorization is for allowing a third-party entity to represent a client (e.g., a company) in tax matters before a tax agency, such as the Internal Revenue Service. This third-party authorization may be, for example, a “Power of Attorney”. A Power of Attorney allows the third-party entity to act in the client's behalf in a legal capacity. In other words, the authorized third-party entity can, for example, advocate, negotiate, and sign on the client's behalf regarding a tax-related matter. The second reason for granting the authorization is to allow the third-party entity to receive and inspect confidential tax information corresponding to the client from the tax agency. Tax agencies require third-party authorizations because it defends against unauthorized entities from obtaining sensitive client tax information for illegal or criminal purposes, such as, for example, tax fraud.

### SUMMARY

According to one illustrative embodiment, a computer-implemented method for electronic submission of tax profile authorizations via a network is provided. A computer populates a tax profile authorization form corresponding to a tax agency in order for a third-party entity to respond to employment tax matters on behalf of a client before the tax agency using stored information in a set of tax profile jurisdiction databases created by the client. The computer applies an electronic signature of an authorized signer of the client to the tax profile authorization form to create a signed tax profile authorization form. The computer submits the signed tax profile authorization form to the tax agency via the network enabling the third-party entity to respond to employment tax matters on behalf of the client before the tax agency. The computer displays an indication on a tax profile authorization dashboard that the signed tax profile authorization form has been submitted to the tax agency. The computer displays third-party administrator authorization with client information and tax jurisdiction on the tax profile authorization dashboard, along with timestamp of the electronic signature of the authorized signer for verification and fraud prevention.

According to another illustrative embodiment, a computer system for electronic submission of tax profile authorizations via a network is provided. The computer system comprises a bus system, a storage device storing program instructions connected to the bus system, and a processor executing the program instructions connected to the bus system. The computer system populates a tax profile authorization form corresponding to a tax agency in order for a third-party entity to respond to employment tax matters on behalf of a client before the tax agency using stored information in a set of tax profile jurisdiction databases created by the client. The computer system applies an electronic signature of an authorized signer of the client to the tax profile authorization form to create a signed tax profile authorization form. The computer system submits the signed tax profile authorization form to the tax agency via the network enabling the third-party entity to respond to employment tax matters on behalf of the client before the tax agency. The computer system displays an indication on a tax profile authorization dashboard that the signed tax profile authorization form has been submitted to the tax agency. The computer system displays third-party administrator authorization with client information and tax jurisdiction on the tax profile authorization dashboard, along with timestamp of the electronic signature of the authorized signer for verification and fraud prevention.

According to another illustrative embodiment, a computer program product for electronic submission of tax profile authorizations via a network is provided. The computer program product comprises a computer readable storage medium having program instructions embodied therewith, the program instructions executable by a computer to cause the computer to perform a method. The computer populates a tax profile authorization form corresponding to a tax agency in order for a third-party entity to respond to employment tax matters on behalf of a client before the tax agency using stored information in a set of tax profile jurisdiction databases created by the client. The computer applies an electronic signature of an authorized signer of the client to the tax profile authorization form to create a signed tax profile authorization form. The computer submits the signed tax profile authorization form to the tax agency via the network enabling the third-party entity to respond to employment tax matters on behalf of the client before the tax agency. The computer displays an indication on a tax profile authorization dashboard that the signed tax profile authorization form has been submitted to the tax agency. The computer displays third-party administrator authorization with client information and tax jurisdiction on the tax profile authorization dashboard, along with timestamp of the electronic signature of the authorized signer for verification and fraud prevention.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a tax profile authorization dashboard in accordance with an illustrative embodiment;

FIGS. 4A-4C are a flowchart illustrating a process for automatically completing a tax profile authorization form, applying an e-signature of an authorized signer to the tax profile authorization form, and submitting the tax profile authorization form to a tax agency in accordance with an illustrative embodiment;

FIG. 5 is a flowchart illustrating a process for submitting a set of tax profile authorization forms signed by an authorized signer in ink to a tax agency in accordance with an illustrative embodiment; and

FIG. 6 is a flowchart illustrating a process for assigning a set of third-party administrator roles to a third-party entity via a tax agency website in accordance with an illustrative embodiment.

### DETAILED DESCRIPTION

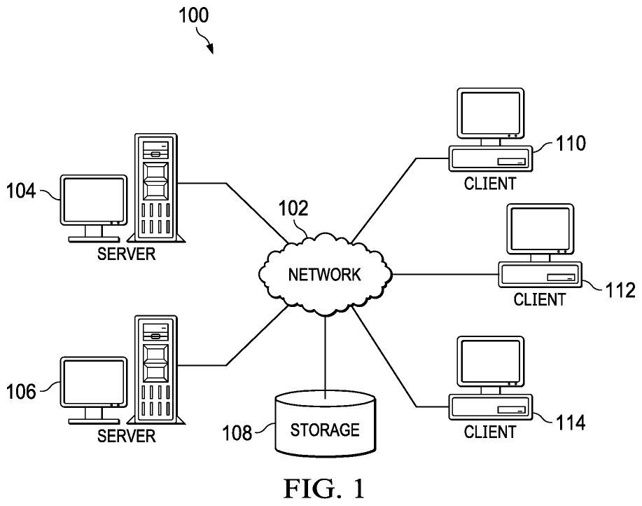

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide employment tax services to registered clients, which have a number of employees, by automatically completing, validating, and submitting tax profile authorizations to tax agencies, such as federal, state, and local taxing authorities, to grant a third-party entity providing the employment tax service permission to act in a registered client's behalf before a tax agency regarding employment tax matters. Also, it should be noted that server 104 and server 106 may each represent a cluster of servers in one or more data centers. Alternatively, server 104 and server 106 may each represent multiple computing nodes in one or more cloud environments.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102. Users of clients 110, 112, and 114 may utilize clients 110, 112, and 114 to access and utilize the employment tax services provided by server 104 and server 106. Further, server 104 and server 106 may provide other information, such as, for example, applications, programs, files, data, and the like to clients 110, 112, and 114.

Storage 108 is a network storage device capable of storing any type of data in a structured format or an unstructured format. In addition, storage 108 may represent a plurality of network storage devices. Further, storage 108 may represent a plurality of tax profile jurisdiction databases created by a plurality of different clients. Each particular tax profile jurisdiction database may contain information, such as name, location, tax identifier, and tax jurisdiction and type (e.g., federal, state, local, social security, unemployment, workers compensation, and the like), regarding an operational unit (e.g., store, warehouse, regional office, or the like) of a particular client. Server 104 and server 106 utilize the information stored in the tax profile jurisdiction databases to populate tax profile authorization forms and validate information. Furthermore, storage 108 may store other types of data, such as authentication or credential data that may include user names, passwords, and biometric data associated with client device users and system administrators, for example. Other credential data can include addresses, social security numbers, and the like.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

As used herein, when used with reference to items, “a number of” means one or more items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

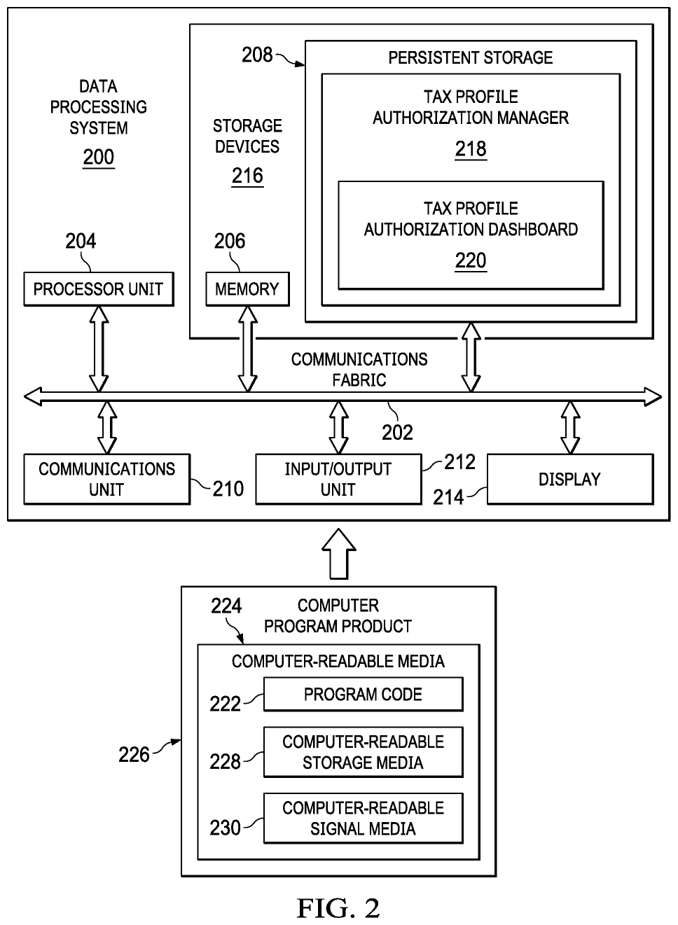

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments for providing employment tax services may be located. A third-party entity, which provides the employment tax services, owns or controls data processing system 200. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer readable storage device or medium is any piece of hardware that is capable of storing information, such as, for example, without limitation, data, computer readable program instructions in functional form, and/or other suitable information either on a transient basis or a persistent basis. Further, a computer readable storage device or medium excludes a propagation medium, such as a transitory signal. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores tax profile authorization manager 218. However, it should be noted that even though tax profile authorization manager 218 is illustrated as residing in persistent storage 208, in an alternative illustrative embodiment tax profile authorization manager 218 may be a separate component of data processing system 200. For example, tax profile authorization manager 218 may be a hardware component coupled to communication fabric 202 or a combination of hardware and software components. In another alternative illustrative embodiment, a first set of components of tax profile authorization manager 218 may be located in data processing system 200 and a second set of components of tax profile authorization manager 218 may be located in a second data processing system, such as, for example, server 106 or client 110 in FIG. 1.

Tax profile authorization manager 218 controls the process of obtaining tax profile authorizations from authorized signers, such as financial officers, accountants, executives, and the like of clients, who are allowed to sign tax profile authorizations for the clients. Tax profile authorization manager 218 generates tax profile authorization dashboard 220 for users, such as authorized signers and third-party entity users, to engage with tax profile authorization manager 218 and request and provide information, such as electronic signatures of authorized signers. Tax profile authorization dashboard 220 is an improved graphical user interface that enables automatic population, validation, organization, and submission of tax profile authorizations, which decreases user time, effort, and errors, increases speed and efficiency of tax profile authorization submissions to tax agencies, and decreases likelihood of occurrences of tax fraud. It should be noted that tax profile authorization manager 218 is coupled via a network, such as network 102 in FIG. 1, to one or more tax profile jurisdiction databases created by registered clients, such as storage 108 in FIG. 1, to automatically populate tax profile authorizations with required information and validate information provided by authorized signers. The tax profile authorizations grant the third-party entity providing the employment tax service the authority to act in a registered client's behalf before a tax agency regarding employment tax matters, such as responding to tax notices, filing tax forms, remitting taxes, and the like.

As a result, data processing system 200 operates as a special purpose computer system in which tax profile authorization manager 218 in data processing system 200 enables fast and efficient electronic submission of tax profile authorizations to tax agencies via a network allowing an authorized third-party administrator to timely act in behalf of a client before a tax agency. In particular, tax profile authorization manager 218 transforms data processing system 200 into a special purpose computer system as compared to currently available general computer systems that do not have tax profile authorization manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth© technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 222 is located in a functional form on computer readable media 224 that is selectively removable and may be loaded onto or transferred to data processing system 200 for running by processor unit 204. Program code 222 and computer readable media 224 form computer program product 226. In one example, computer readable media 224 may be computer readable storage media 228 or computer readable signal media 230.

In these illustrative examples, computer readable storage media 228 is a physical or tangible storage device used to store program code 222 rather than a medium that propagates or transmits program code 222. In other words, computer readable storage media 228 exclude a propagation medium, such as transitory signals. Computer readable storage media 228 may include, for example, an optical or magnetic disc that is inserted or placed into a drive or other device that is part of persistent storage 208 for transfer onto a storage device, such as a hard drive, that is part of persistent storage 208. Computer readable storage media 228 also may take the form of a persistent storage, such as a hard drive, a thumb drive, or a flash memory that is connected to data processing system 200.

Alternatively, program code 222 may be transferred to data processing system 200 using computer readable signal media 230. Computer readable signal media 230 may be, for example, a propagated data signal containing program code 222. For example, computer readable signal media 230 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 224” can be singular or plural. For example, program code 222 can be located in computer readable media 224 in the form of a single storage device or system. In another example, program code 222 can be located in computer readable media 224 that is distributed in multiple data processing systems. In other words, some instructions in program code 222 can be located in one data processing system while other instructions in program code 222 can be located in one or more other data processing systems. For example, a portion of program code 222 can be located in computer readable media 224 in a server computer while another portion of program code 222 can be located in computer readable media 224 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 222.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Tax profile authorizations are used by clients, such as, for example, companies, enterprises, organizations, institutions, and the like that have a number of employees, to give a third-party entity providing employment tax services permission to act in the client's behalf regarding employment tax matters with tax agencies. Tax profile authorizations may include, for example, third-party administrator authorization, power of attorney, reporting agent authorization, and the like, depending on the particular tax agency requiring the authorization. A tax profile authorization provides the entity with the power to act as a third-party administrator or representative for a client before a tax agency, such as, for example, a federal government taxing authority, a state government taxing authority, a local government taxing authority, and the like. As used herein, the third-party administrator is not directly associated with the client, but is an independent entity providing the employment tax service. The employment tax service may be, for example, incorporated into a suite of services, such as SmartCompliance®, which is a product of Automatic Data Processing, Inc. of New Jersey.

Illustrative embodiments collect all of the tax profile authorizations that the entity requires to act as a third-party administrator from a client based on the tax jurisdictions that the client operates within, organize the tax profile authorizations into one of three categories, and direct a user of illustrative embodiments (e.g., an authorized signer, such as a tax practitioner, tax account, tax specialist, director, officer, executive, or the like of the client) to complete and/or sign the required tax profile authorizations. The authorized signer is a person who is specifically empowered or appointed by the client to sign the required tax profile authorizations on behalf of the client. The three categories represent one of three ways a tax profile authorization is provided to the third-party entity. In other words, the three categories represent how illustrative embodiments organize tax profile authorizations based on how the authorized signer completes and/or signs the tax profile authorizations. The first category requires the authorized signer to provide an e-signature on the tax profile authorization forms. The second category requires the authorized signer to download the tax profile authorization forms, physically sign the tax profile authorization forms in ink, and upload the signed tax profile authorization forms to the third-party entity. The third category requires the authorized signer to access the client's account on the tax agency's website to assign one or more third-party administrator roles to the third-party entity.

Clients that have incomplete or missing tax profile authorizations have delays in responding to employment tax matters, such as, for example, responding to tax agency notices or paying employer portions of employee taxes to a tax agency, which may cause interest and penalties to be assessed by the tax agency, because the third-party entity cannot timely handle these matters until allowed to do so via completed and signed tax profile authorizations by an authorized signer of the client. However, requesting and receiving these tax profile authorizations is difficult to track, organize, and store via current solutions, such as, for example, emails, faxes, and phone calls. Further, current solutions are susceptible to entry errors and tax fraud.

While onboarding a new client for employment tax services provided by the third-party entity, illustrative embodiments collect information regarding the new client's operational units (e.g., headquarters, regional offices, distribution centers, stores, and the like) and their corresponding tax jurisdictions. Based on the collected information (i.e., name and location of each operational unit of the new client, along with the corresponding tax jurisdiction of each operational unit), illustrative embodiments identify which tax profile authorizations are required in order for the third-party entity to act on the client's behalf as an authorized third-party administrator and then transmit the required tax profile authorization forms to an authorized signer of the client for completion and/or signature.

Issues with current solutions that illustrative embodiments take into account and address are speed of completion of tax profile authorizations and their organization, resulting in faster submissions to tax agencies for handling tax matters by the third-party entity in a timely manner. Another issue with current solutions that illustrative embodiments take into account and address is identifying which tax profile authorizations are needed by tax agencies for each tax jurisdiction associated with a client. Currently, a person needs to manually look up all tax jurisdictions that the client is operating within, and then has to figure out and manually gather all of the tax profile authorizations needed for those tax jurisdictions. Illustrative embodiments systematically address this issue by maintaining a set of databases of all known tax profile authorizations needed for all client jurisdictions. When a client submits their specific tax jurisdictions, illustrative embodiments know which tax profile authorizations are needed for the client for each particular tax jurisdiction. This process also prevents missing tax profile authorizations that may occur from manual work.

Illustrative embodiments pre-populate the tax profile authorization forms with known information retrieved from a set of tax profile jurisdiction databases, which are created by the client and contain tax profiles for each of the different operational units of the client in their respective tax jurisdictions. However, it should be noted that illustrative embodiments ask authorized signers to enter missing or incomplete information on the tax profile authorization forms that illustrative embodiments could not retrieve from the set of tax profile jurisdiction databases. Illustrative embodiments highlight the missing or incomplete information on the tax profile authorization forms for entry by the authorized signer. Afterward, illustrative embodiments request that the authorized signer review and then sign the completed tax profile authorization forms via electronic signature (e-signature) or ink signature. Alternatively, illustrative embodiments may request that the authorized signer access the tax agency's website to assign one or more third-party administrator roles to the third-party entity.

The organization of how the tax profile authorizations are to be completed by authorized signers is new and different from current solutions. Further, illustrative embodiments enable application of the authorized signer's e-signature to all related tax profile authorization forms in bulk, at a same time, allowing faster submission to the third-party entity for efficient processing, while decreasing authorized user time and effort and eliminating missed authorizations. Thus, illustrative embodiments provide an improved graphical user interface for increasing user efficiency and decreasing errors.

Furthermore, illustrative embodiments may prevent or reduce tax fraud by validating information provided by a selected authorized signer and requiring the validated authorized signer to complete and/or sign the tax profile authorizations for the corresponding client. Moreover, illustrative embodiments enable visualization of who is logged on to the employment tax service dashboard (i.e., authorized signer) while completing and/or electronically signing the tax profile authorizations. Illustrative embodiments also provide a timestamp (e.g., date and time) for recordation and verification of the authorized signer's electronic signature. In addition, illustrative embodiments receive validation of third-party administrator role assignments from tax agencies.

Thus, illustrative embodiments provide one or more technical solutions that overcome a technical problem with timely and efficient electronic tax profile authorization submissions to tax agencies via a network. As a result, these one or more technical solutions provide a technical effect and practical application in the field of network electronic submissions for tax compliance and tax fraud reduction.

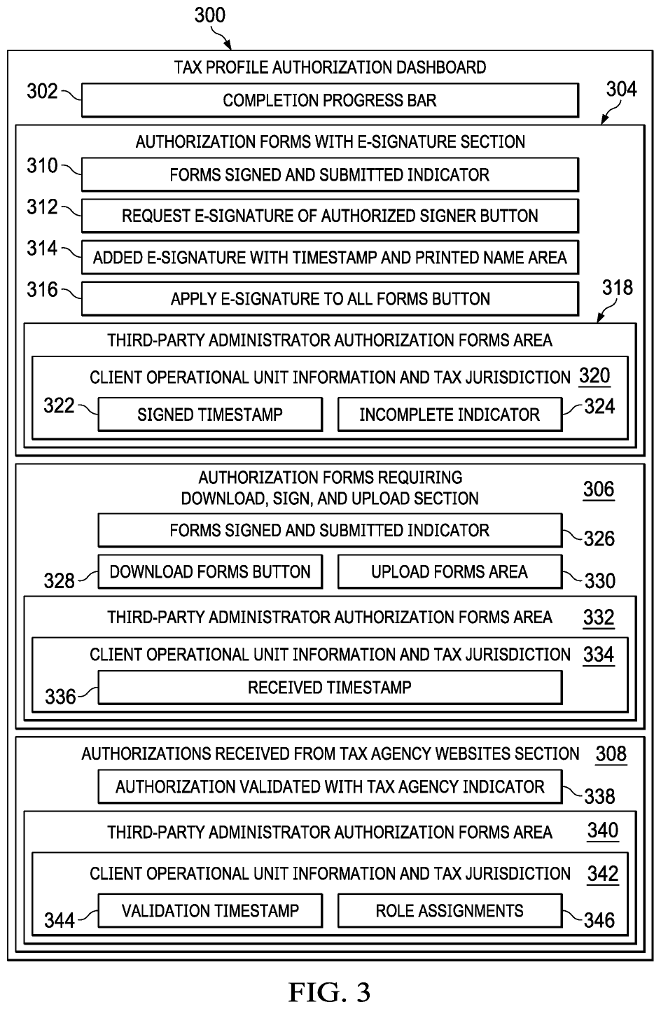

With reference now to FIG. 3, a diagram illustrating an example of a tax profile authorization dashboard is depicted in accordance with an illustrative embodiment. Tax profile authorization dashboard 300 may be implemented in a computer, such as server 104 in FIG. 1 or data processing system 200 in FIG. 2. For example, tax profile authorization dashboard 300 may be tax profile authorization dashboard 220 in FIG. 2.

Tax profile authorization dashboard 300 enables completion of tax profile authorizations and submission thereof to one or more tax agencies providing an authorized third-party entity permission to act in a client's behalf regarding employment tax matters before the tax agencies. In this example, tax profile authorization dashboard 300 includes completion progress bar 302, authorization forms with e-signature section 304, authorization forms requiring download, sign, and upload section 306, and authorizations received from tax agency websites section 308. However, it should be noted that tax profile authorization dashboard 300 is intended as an example only and not as a limitation on different illustrative embodiments. For example, an alternative illustrative embodiment may include additional information not shown or remove information shown.

Tax profile authorization dashboard 300 utilizes completion progress bar 302 to enable a user to quickly visualize progress, such as, for example, total number of tasks to be performed, number of tasks successfully completed, and number of tasks yet to be completed. Tax profile authorization dashboard 300 organizes tax profile authorizations into one of three sections, such as authorization forms with e-signature section 304, authorization forms requiring download, sign, and upload section 306, and authorizations received from tax agency websites section 308.

Authorization forms with e-signature section 304 is a section for tax profile authorization forms that were signed by an authorized signer of a client with an electronic signature (e-signature) on tax profile authorization dashboard 300. In this example, authorization forms with e-signature section 304 includes forms signed and submitted indicator 310, request e-signature of authorized signer button 312, added e-signature with timestamp and printed name area 314, apply e-signature to all forms button 316, and third-party administrator authorization forms area 318.

Tax profile authorization dashboard 300 utilizes forms signed and submitted indicator 310 to indicate to the user which tax profile authorizations have already been signed and submitted. Tax profile authorization dashboard 300 utilizes request e-signature of authorized signer button 312 to enable a third-party entity user to request an e-signature on a tax profile authorization from a selected authorized signer. Tax profile authorization dashboard 300 utilizes added e-signature with timestamp and printed name area 314 to enable a user to see an added e-signature of the selected authorized signer, along with a timestamp of when the e-signature was added and a printed name of the authorized signer. Tax profile authorization dashboard 300 utilizes apply e-signature to all forms button 316 to enable the authorized signer to apply the e-signature of the authorized signer in bulk, at a same time, to all related tax profile authorizations. Tax profile authorization dashboard 300 utilizes third-party administrator authorization forms area 318 to display all current tax profile authorizations.

In this example, third-party administrator authorization forms area 318 includes client operational unit information and tax jurisdiction 320, signed timestamp 322, and incomplete indicator 324. Client operational unit information and tax jurisdiction 320 indicates a corresponding operational unit of the client, the tax jurisdiction associated with the operational unit, tax identifier of the operational unit, type of employment tax required for that operational unit, and the like. Signed timestamp 322 provides an indication of when the e-signature of the authorized signer was applied to the tax profile authorization. Incomplete indicator 324 provides an indication that information and/or signature is missing from a particular tax profile authorization.

Authorization forms requiring download, sign, and upload section 306 is a section for tax profile authorization forms that were downloaded, signed by the authorized signer in ink, and upload to tax profile authorization dashboard 300. In this example, authorization forms requiring download, sign, and upload section 306 includes forms signed and submitted indicator 326, download forms button 328, upload forms area 330, and third-party administrator authorization forms area 332.

Forms signed and submitted indicator 326 is similar to forms signed and submitted indicator 310 above and indicates which tax profile authorizations have already been signed and submitted. Tax profile authorization dashboard 300 utilizes download forms button 328 to enable the authorized signer to download a set of tax profile authorization requiring an ink signature by the authorized signer. Tax profile authorization dashboard 300 utilizes upload forms area 330 to enable the authorized signer to upload the set of tax profile authorizations signed signer in ink by the authorized. Third-party administrator authorization forms area 332 is similar to third-party administrator authorization forms area 332 above and includes client operational unit information and tax jurisdiction 334 and received timestamp 336. Client operational unit information and tax jurisdiction 334 indicates a corresponding operational unit of the client, the tax jurisdiction associated with the operational unit, tax identifier of the operational unit, type of employment tax required for that operational unit, and the like. Received timestamp 336 provides an indication of when the tax profile authorization with ink signature was received by tax profile authorization dashboard 300.

Authorizations received from tax agency websites section 308 is a section where third-party administrator roles were assigned by the authorized signer on one or more websites corresponding to one or more tax agencies and validated by the tax agencies. In this example, authorizations received from tax agency websites section 308 includes authorization validated with tax agency indicator 338 and third-party administrator authorization forms area 340. Tax profile authorization dashboard 300 utilizes authorization validated with tax agency indicator 338 to provide an indication to the user which tax profile authorizations have been validated with the tax agencies.

Third-party administrator authorization forms area 340 is similar to third-party administrator authorization forms area 318 and third-party administrator authorization forms area 332 above and includes client operational unit information and tax jurisdiction 342, validation timestamp 344, and role assignments 346. Client operational unit information and tax jurisdiction 342 indicates a corresponding operational unit of the client, the tax jurisdiction associated with the operational unit, tax identifier of the operational unit, type of employment tax required for that operational unit, and the like. Validation timestamp 344 indicates when the role assignments 346 were validated by a tax agency. Role assignments 346 indicate the particular activities the authorized third-party entity is allowed to perform, such as pay taxes, respond to tax notices, and the like.

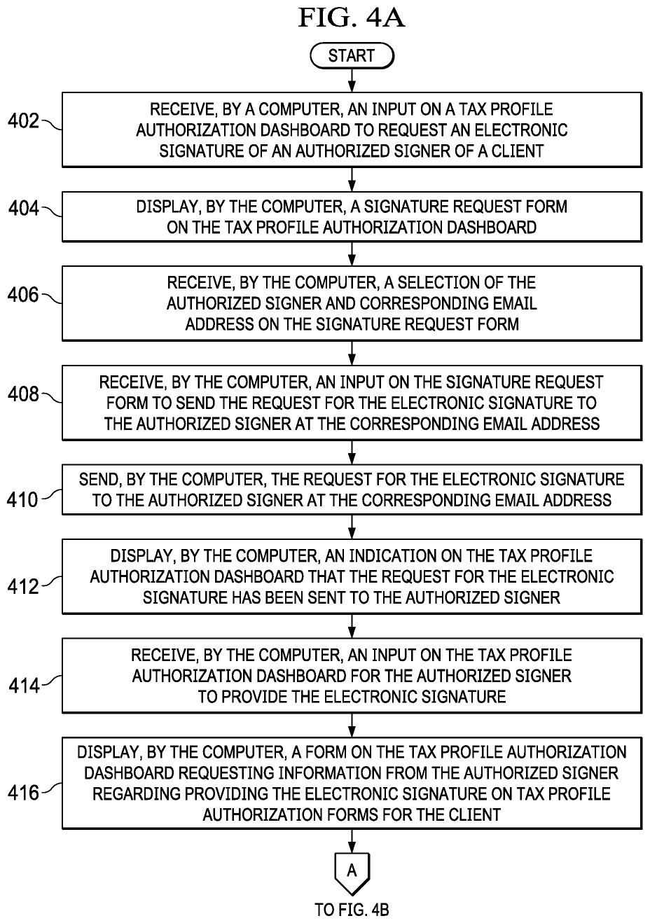

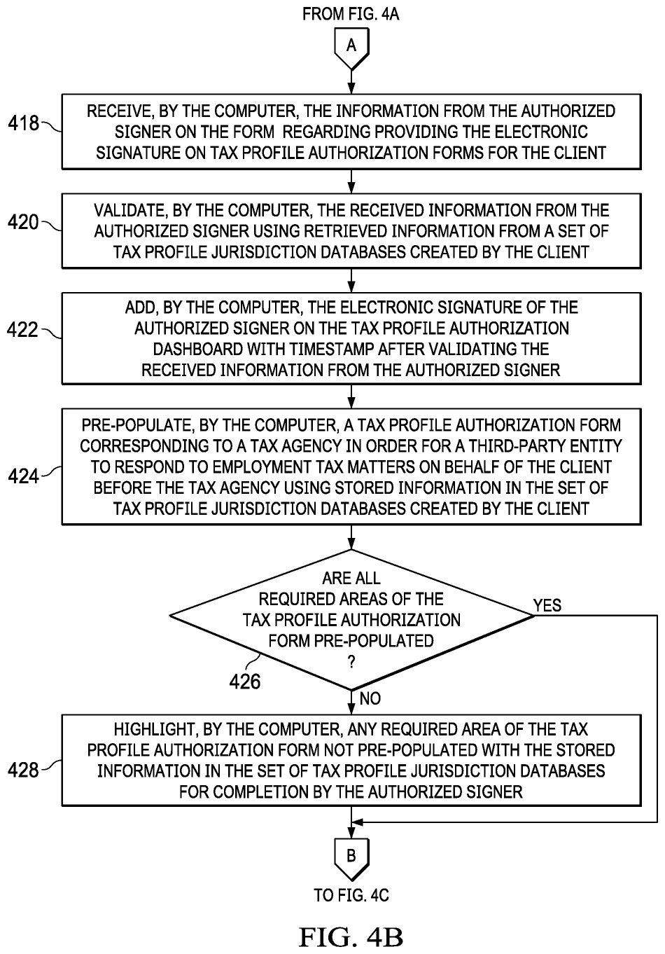

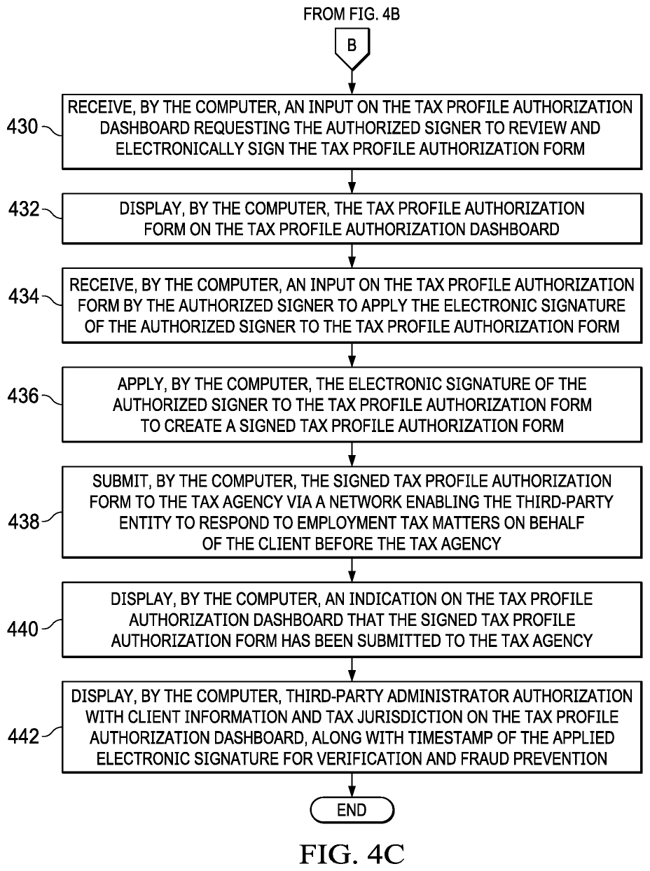

With reference now to FIGS. 4A-4C, a flowchart illustrating a process for automatically completing a tax profile authorization form, applying an e-signature of an authorized signer to the tax profile authorization form, and submitting the tax profile authorization form to a tax agency is shown in accordance with an illustrative embodiment. The process shown in FIGS. 4A-4C may be implemented in a computer, such as, for example, server 104 in FIG. 1 or data processing system 200 in FIG. 2. For example, the process can be implemented in tax profile authorization dashboard 220 in FIG. 2.

The process begins when the computer receives an input on a tax profile authorization dashboard to request an electronic signature of an authorized signer of a client (step 402). In response, the computer displays a signature request form on the tax profile authorization dashboard (step 404). Subsequently, the computer receives a selection of the authorized signer and corresponding email address on the signature request form (step 406).

The computer also receives an input on the signature request form to send the request for the electronic signature to the authorized signer at the corresponding email address (step 408). In response, the computer sends the request for the electronic signature to the authorized signer at the corresponding email address (step 410). The computer displays an indication on the tax profile authorization dashboard that the request for the electronic signature has been sent to the authorized signer (step 412).

In addition, the computer receives an input on the tax profile authorization dashboard for the authorized signer to provide the electronic signature (step 414). The computer displays a form on the tax profile authorization dashboard requesting information from the authorized signer regarding an ability of the authorized signer to provide the electronic signature on tax profile authorization forms for the client (step 416). Afterward, the computer receives the information from the authorized signer on the form regarding the ability of the authorized signer to provide the electronic signature on tax profile authorization forms for the client (step 418).

The computer validates the received information from the authorized signer using retrieved information from a set of tax profile jurisdiction databases created by the client (step 420). In addition, a database validates the information of name, address, social security number, and the like of the authorized signer to ensure the identity of the authorized signer. The computer adds the electronic signature of the authorized signer on the tax profile authorization dashboard with timestamp after validating the received information from the authorized signer (step 422). Furthermore, the computer pre-populates a tax profile authorization form corresponding to a tax agency in order for a third-party entity to respond to employment tax matters on behalf of the client before the tax agency using stored information in the set of tax profile jurisdiction databases created by the client (step 424).

The computer makes a determination as to whether all required areas of the tax profile authorization form are pre-populated using the stored information in the set of tax profile jurisdiction databases (step 426). If the computer determines that all required areas of the tax profile authorization form are pre-populated, yes output of step 426, then the process proceeds to step 430. If the computer determines that not all required areas of the tax profile authorization form are pre-populated, no output of step 426, then the computer highlights any required area of the tax profile authorization form not pre-populated with the stored information in the set of tax profile jurisdiction databases for completion by the authorized signer (step 428).

Subsequently, the computer receives an input on the tax profile authorization dashboard requesting the authorized signer to review and sign the tax profile authorization form (step 430). The computer displays the tax profile authorization form on the tax profile authorization dashboard (step 432). The computer receives an input on the tax profile authorization form by the authorized signer to apply the electronic signature of the authorized signer to the tax profile authorization form (step 434).

In response to receiving the input in step 434, the computer applies the electronic signature of the authorized signer to the tax profile authorization form to create a signed tax profile authorization form (step 436). The computer submits the signed tax profile authorization form to the tax agency via a network enabling the third-party entity to respond to employment tax matters on behalf of the client before the tax agency (step 438). The computer displays an indication on the tax profile authorization dashboard that the signed tax profile authorization form has been submitted to the tax agency (step 440). In addition, the computer displays the third-party administrator authorization with client information and tax jurisdiction on the tax profile authorization dashboard, along with timestamp of the applied electronic signature for verification and fraud prevention (step 442). Thereafter, the process terminates.

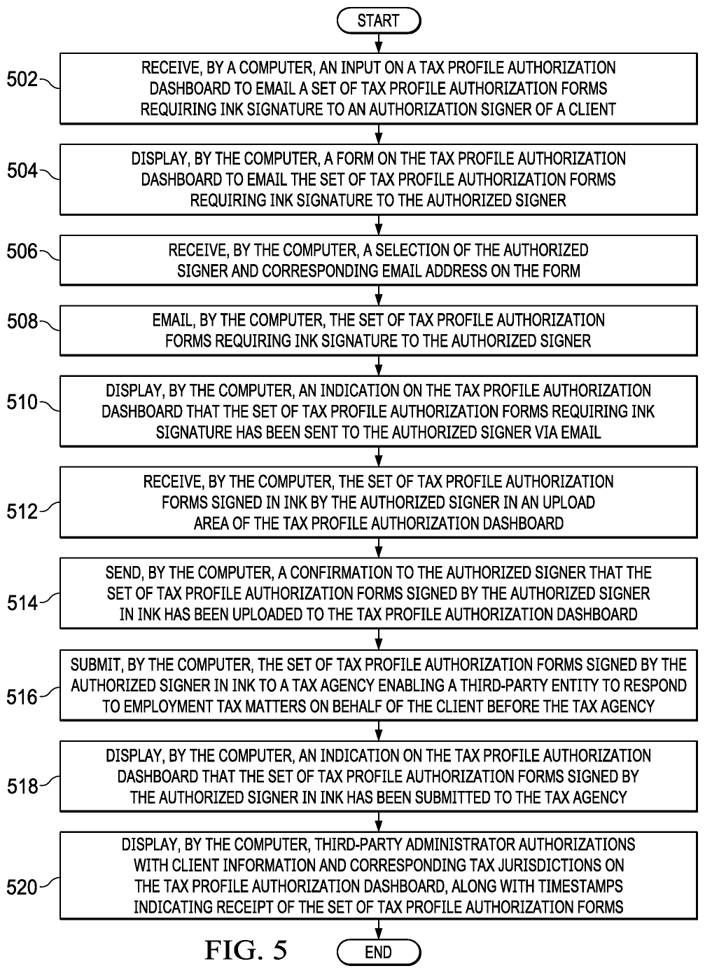

With reference now to FIG. 5, a flowchart illustrating a process for submitting a set of tax profile authorization forms signed by an authorized signer in ink to a tax agency is shown in accordance with an illustrative embodiment. The process shown in FIG. 5 may be implemented in a computer, such as, for example, server 104 in FIG. 1 or data processing system 200 in FIG. 2. For example, the process can be implemented in tax profile authorization dashboard 220 in FIG. 2.

The computer receives an input on the tax profile authorization dashboard to email a set of tax profile authorization forms requiring ink signature to an authorized signer of a client (step 502). The computer displays a form on the tax profile authorization dashboard to email the set of tax profile authorization forms requiring ink signature to the authorized signer (step 504). Subsequently, the computer receives a selection of the authorized signer and corresponding email address on the form (step 506).

The computer emails the set of tax profile authorization forms requiring ink signature to the authorized signer at the corresponding email address (step 508). The computer also displays an indication on the tax profile authorization dashboard that the set of tax profile authorization forms requiring ink signature has been sent to the authorized signer via email (step 510).

Afterward, the computer receives the set of tax profile authorization forms signed in ink by the authorized signer in an upload area of the tax profile authorization dashboard (step 512). Further, the computer sends a confirmation to the authorized signer that the set of tax profile authorization forms signed by the authorized signer in ink has been uploaded to the tax profile authorization dashboard (step 514).

The computer submits the set of tax profile authorization forms signed by the authorized signer in ink to a tax agency via a network enabling a third-party entity to respond to employment tax matters on behalf of the client before the tax agency (step 516). Furthermore, the computer displays an indication on the tax profile authorization dashboard that the set of tax profile authorization forms signed by the authorized signer in ink has been submitted to the tax agency (step 518). Moreover, the computer displays the third-party administrator authorizations with client information and corresponding tax jurisdictions on the tax profile authorization dashboard, along with timestamps indicating receipt of the set of tax profile authorization forms (step 520). Thereafter, the process terminates.

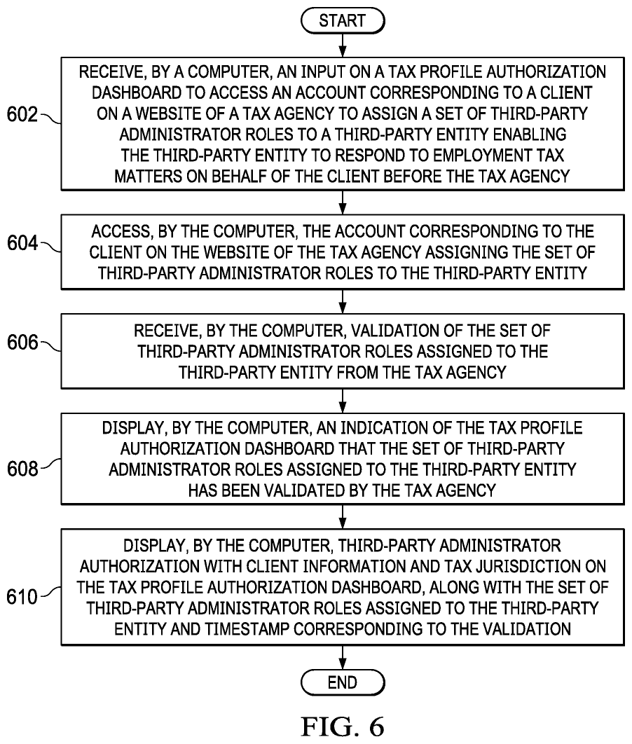

With reference now to FIG. 6, a flowchart illustrating a process for assigning a set of third-party administrator roles to a third-party entity via a tax agency website is shown in accordance with an illustrative embodiment. The process shown in FIG. 6 may be implemented in a computer, such as, for example, server 104 in FIG. 1 or data processing system 200 in FIG. 2. For example, the process can be implemented in tax profile authorization dashboard 220 in FIG. 2.

The computer receives an input on a tax profile authorization dashboard to access an account corresponding to a client on a website of a tax agency to assign a set of third-party administrator roles to a third-party entity enabling the third-party entity to respond to employment tax matters on behalf of the client before the tax agency (step 602). The set of third-party administrator roles are at least one of filing employment taxes with tax agencies, depositing employment taxes corresponding to employees with the tax agencies, responding to tax notices from the tax agencies, and the like. In response to receiving the input in step 602, the computer accesses the account corresponding to the client on the website of the tax agency via a network assigning the set of third-party administrator roles to the third-party entity (step 604).

Subsequently, the computer receives validation of the set of third-party administrator roles assigned to the third-party entity from the tax agency (step 606). The computer displays an indication on the tax profile authorization dashboard that the set of third-party administrator roles assigned to the third-party entity has been validated by the tax agency (step 608). In addition, the computer displays the third-party administrator authorization with client information and tax jurisdiction on the tax profile authorization dashboard, along with the set of third-party administrator roles assigned to the third-party entity and timestamp corresponding to the tax agency validation (step 610). Thereafter, the process terminates.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

Thus, illustrative embodiments of the present invention provide a computer-implemented method, computer system, and computer program product for automatically completing, validating, and submitting tax profile authorizations to give a third-party entity providing an employment tax service permission to act in a client's behalf before a tax agency regarding employment tax matters. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for electronic submission of tax profile authorizations via a network, the computer-implemented method comprising:
populating, by a computer, a tax profile authorization form corresponding to a tax agency in order for a third-party entity to respond to employment tax matters on behalf of a client before the tax agency using stored information in a set of tax profile jurisdiction databases created by the client;
applying, by the computer, an electronic signature of an authorized signer of the client to the tax profile authorization form to create a signed tax profile authorization form;
submitting, by the computer, the signed tax profile authorization form to the tax agency via the network enabling the third-party entity to respond to employment tax matters on behalf of the client before the tax agency;
displaying, by the computer, an indication on a tax profile authorization dashboard that the signed tax profile authorization form has been submitted to the tax agency; and
displaying, by the computer, third-party administrator authorization with client information and tax jurisdiction on the tax profile authorization dashboard, along with timestamp of the electronic signature of the authorized signer for verification and fraud prevention.

2. The computer-implemented method of claim 1 further comprising:
determining, by the computer, whether required areas of the tax profile authorization form are populated using the stored information in the set of tax profile jurisdiction databases;
responsive to the computer determining that one or more required areas of the tax profile authorization form are not populated, highlighting, by the computer, any required area of the tax profile authorization form not populated for completion by the authorized signer;
receiving, by the computer, an input on the tax profile authorization dashboard requesting the authorized signer to review and electronically sign the tax profile authorization form;
displaying, by the computer, the tax profile authorization form on the tax profile authorization dashboard; and
receiving, by the computer, an input on the tax profile authorization form by the authorized signer to apply the electronic signature of the authorized signer to the tax profile authorization form.

3. The computer-implemented method of claim 1 further comprising:
receiving, by the computer, an input on the tax profile authorization dashboard for the authorized signer to provide the electronic signature;
displaying, by the computer, a form on the tax profile authorization dashboard requesting information from the authorized signer regarding an ability of the authorized signer to provide the electronic signature on the tax profile authorization form for the client;
receiving, by the computer, the information from the authorized signer on the form regarding the ability of the authorized signer to provide the electronic signature on the tax profile authorization form for the client; and
validating, by the computer, the information received from the authorized signer using retrieved information from the set of tax profile jurisdiction databases created by the client.

4. The computer-implemented method of claim 3 further comprising:
adding, by the computer, the electronic signature of the authorized signer on the tax profile authorization dashboard with timestamp after validating the information received from the authorized signer.

5. The computer-implemented method of claim 1 further comprising:
receiving, by the computer, an input on the tax profile authorization dashboard requesting the electronic signature of the authorized signer;
displaying, by the computer, a signature request form on the tax profile authorization dashboard;
receiving, by the computer, a selection of the authorized signer and corresponding email address on the signature request form;
receiving, by the computer an input on the signature request form to send the request for the electronic signature to the authorized signer at the corresponding email address;
sending, by the computer, the request for the electronic signature to the authorized signer at the corresponding email address; and
displaying, by the computer, an indication on the tax profile authorization dashboard that the request for the electronic signature has been sent to the authorized signer.

6. The computer-implemented method of claim 1 further comprising:
receiving, by the computer, an input on the tax profile authorization dashboard to email a set of tax profile authorization forms requiring ink signature to the authorized signer of the client;
emailing, by the computer, the set of tax profile authorization forms requiring ink signature to the authorized signer at a corresponding email address; and
displaying, by the computer, an indication on the tax profile authorization dashboard that the set of tax profile authorization forms requiring ink signature has been sent to the authorized signer via email.

7. The computer-implemented method of claim 6 further comprising:
receiving, by the computer, the set of tax profile authorization forms signed in ink by the authorized signer in an upload area of the tax profile authorization dashboard;
sending, by the computer, a confirmation to the authorized signer that the set of tax profile authorization forms signed by the authorized signer in ink has been uploaded to the tax profile authorization dashboard; and
submitting, by the computer, the set of tax profile authorization forms signed by the authorized signer in ink to a tax agency via the network enabling the third-party entity to respond to employment tax matters on behalf of the client before the tax agency.

8. The computer-implemented method of claim 1 further comprising:
receiving, by the computer, an input on the tax profile authorization dashboard to access an account corresponding to the client on a website of the tax agency to assign a set of third-party administrator roles to the third-party entity enabling the third-party entity to respond to employment tax matters on behalf of the client before the tax agency;
accessing, by the computer, the account corresponding to the client on the website of the tax agency via the network assigning the set of third-party administrator roles to the third-party entity;
receiving, by the computer, validation of the set of third-party administrator roles assigned to the third-party entity from the tax agency; and
displaying, by the computer, an indication on the tax profile authorization dashboard that the set of third-party administrator roles assigned to the third-party entity has been validated by the tax agency.

9. The computer-implemented method of claim 8, wherein the set of third-party administrator roles is at least one of filing tax forms with the tax agency, depositing employment taxes corresponding to employees with the tax agency, and responding to tax notices from the tax agency.

10. The computer-implemented method of claim 1, wherein the computer applies the electronic signature of the authorized signer to related tax profile authorizations in bulk at a same time.

11. The computer-implemented method of claim 1, wherein the tax profile authorization form is one of a third-party administrator authorization, a power of attorney, and a reporting agent authorization.

12. The computer-implemented method of claim 1, wherein the tax agency is one of a federal government taxing authority, a state government taxing authority, and a local government taxing authority.

13. A computer system for electronic submission of tax profile authorizations via a network, the computer system comprising:
a bus system;
a storage device connected to the bus system, wherein the storage device stores program instructions; and
a processor connected to the bus system, wherein the processor executes the program instructions to:
populate a tax profile authorization form corresponding to a tax agency in order for a third-party entity to respond to employment tax matters on behalf of a client before the tax agency using stored information in a set of tax profile jurisdiction databases created by the client;
apply an electronic signature of an authorized signer of the client to the tax profile authorization form to create a signed tax profile authorization form;
submit the signed tax profile authorization form to the tax agency via the network enabling the third-party entity to respond to employment tax matters on behalf of the client before the tax agency;
display an indication on a tax profile authorization dashboard that the signed tax profile authorization form has been submitted to the tax agency; and
display third-party administrator authorization with client information and tax jurisdiction on the tax profile authorization dashboard, along with timestamp of the electronic signature of the authorized signer for verification and fraud prevention.

14. The computer system of claim 13, wherein the processor further executes the program instructions to:
determine whether required areas of the tax profile authorization form are populated using the stored information in the set of tax profile jurisdiction databases;
highlight any required area of the tax profile authorization form not populated for completion by the authorized signer in response to determining that one or more required areas of the tax profile authorization form are not populated;
receive an input on the tax profile authorization dashboard requesting the authorized signer to review and electronically sign the tax profile authorization form;
display the tax profile authorization form on the tax profile authorization dashboard; and
receive an input on the tax profile authorization form by the authorized signer to apply the electronic signature of the authorized signer to the tax profile authorization form.

15. The computer system of claim 13, wherein the processor further executes the program instructions to:
receive an input on the tax profile authorization dashboard for the authorized signer to provide the electronic signature;
display a form on the tax profile authorization dashboard requesting information from the authorized signer regarding an ability of the authorized signer to provide the electronic signature on the tax profile authorization form for the client;
receive the information from the authorized signer on the form regarding the ability of the authorized signer to provide the electronic signature on the tax profile authorization form for the client; and
validate the information received from the authorized signer using retrieved information from the set of tax profile jurisdiction databases created by the client.

16. A computer program product for electronic submission of tax profile authorizations via a network, the computer program product comprising a computer readable storage medium having program instructions embodied therewith, the program instructions executable by a computer to cause the computer to perform a method of:
populating, by the computer, a tax profile authorization form corresponding to a tax agency in order for a third-party entity to respond to employment tax matters on behalf of a client before the tax agency using stored information in a set of tax profile jurisdiction databases created by the client;
applying, by the computer, an electronic signature of an authorized signer of the client to the tax profile authorization form to create a signed tax profile authorization form;
submitting, by the computer, the signed tax profile authorization form to the tax agency via the network enabling the third-party entity to respond to employment tax matters on behalf of the client before the tax agency;
displaying, by the computer, an indication on a tax profile authorization dashboard that the signed tax profile authorization form has been submitted to the tax agency; and
displaying, by the computer, third-party administrator authorization with client information and tax jurisdiction on the tax profile authorization dashboard, along with timestamp of the electronic signature of the authorized signer for verification and fraud prevention.

17. The computer program product of claim 16 further comprising:
determining, by the computer, whether required areas of the tax profile authorization form are populated using the stored information in the set of tax profile jurisdiction databases;
responsive to the computer determining that one or more required areas of the tax profile authorization form are not populated, highlighting, by the computer, any required area of the tax profile authorization form not populated for completion by the authorized signer;
receiving, by the computer, an input on the tax profile authorization dashboard requesting the authorized signer to review and electronically sign the tax profile authorization form;
displaying, by the computer, the tax profile authorization form on the tax profile authorization dashboard; and
receiving, by the computer, an input on the tax profile authorization form by the authorized signer to apply the electronic signature of the authorized signer to the tax profile authorization form.

18. The computer program product of claim 16 further comprising:
receiving, by the computer, an input on the tax profile authorization dashboard for the authorized signer to provide the electronic signature;
displaying, by the computer, a form on the tax profile authorization dashboard requesting information from the authorized signer regarding an ability of the authorized signer to provide the electronic signature on the tax profile authorization form for the client;
receiving, by the computer, the information from the authorized signer on the form regarding the ability of the authorized signer to provide the electronic signature on the tax profile authorization form for the client; and
validating, by the computer, the information received from the authorized signer using retrieved information from the set of tax profile jurisdiction databases created by the client.

19. The computer program product of claim 18 further comprising:
adding, by the computer, the electronic signature of the authorized signer on the tax profile authorization dashboard with timestamp after validating the information received from the authorized signer.

20. The computer program product of claim 16 further comprising:
receiving, by the computer, an input on the tax profile authorization dashboard requesting the electronic signature of the authorized signer;
displaying, by the computer, a signature request form on the tax profile authorization dashboard;
receiving, by the computer, a selection of the authorized signer and corresponding email address on the signature request form;
receiving, by the computer an input on the signature request form to send the request for the electronic signature to the authorized signer at the corresponding email address;
sending, by the computer, the request for the electronic signature to the authorized signer at the corresponding email address; and
displaying, by the computer, an indication on the tax profile authorization dashboard that the request for the electronic signature has been sent to the authorized signer.
